(19) United States
(12) Patent Application Publication
(10) Pub. No.: US 2006/0037372 A1
(43) Pub. Date: Feb. 23, 2006

(54) Door lock

(76) Inventor: Barrie Jones, Stockport (GB)

Correspondence Address: DENNISON, SCHULTZ, DOUGHERTY & MACDONALD, 1727 KING STREET, SUITE 105, ALEXANDRIA, VA, 22314, US

(21) Appl. No.: 11/246,213

(22) Filed: Oct. 11, 2005

Related U.S. Application Data
(63) Continuation-in-part of application No. PCT/GB04/01547, filed on Apr. 8, 2004.

(30) Foreign Application Priority Data
Apr. 10, 2003 (GB) 0308223.7

(51) Int. Cl. E05B 47/00

(52) U.S. Cl. 70/276

(57) ABSTRACT

A locking apparatus for a door comprises a key which is engageable with a lock from a first side of the door to enable the door to be unlocked The key, which is preferably a card, is subsequently only removable from its engagement with the lock at a second side of the door remote from the first side. The key is only removable, once engaged in the lock, when the door is again locked, or removal of the key may itself cause locking of the door.

This application is a continuation-in-part of PCT/GB2004/001547 filed on Apr. 8, 2004.

### BACKGROUND OF THE INVENTION

The present invention relates to a locking apparatus and, in particular, to a locking apparatus for use where an increased level of security is required in, for example, hotels and other areas with multi user access.

A wide variety of door locking apparatus are known in the art. Examples of locking apparatus providing additional security and, in particular, the retention of a key for a lock during some point in the operation of the lock and other security features are described below.

JP2002147074 (SANPO Lock Co Ltd) describes a card lock, which retains the card in the lock (unless the card meets particular dimensional requirements).

DE10033043 (NEERINCX Joseph) describes a deposit box where a key is retained in the deposit box until the box is secured into a safe compartment.

U.S. Pat. No. 5,027,553 (VERGARA Florentino) describes a door with an automatic closer, operable after a given delay, so as to close the door in the event of the door being inadvertently left open.

JP2000276622 (HITACHI Information Technology Co Ltd) describes a card lock where information is stored onto a key card about how the card has been operated in the lock so as to record entering and leaving information regarding use of the card with the lock.

As ascertainable from the documents indicated above, the problems of ensuring that an operator does not inadvertently leave a key in a lock or inadvertently leave a door open after use are known problems with security systems.

U.S. Pat. No. 4,288,783 discloses a locking apparatus for a door comprising a lock and a key wherein the key is engageable with the lock at a first side of the door so as to enable the door to be unlocked and is subsequently removed from the lock at a second side of the door remote from the first side. Opening of the door is enabled by an electric striker device. When the door is closed, the electrical striker prevents opening of the door unless a correct key (card) is introduced into the locking device. The card it is moved to the second side of the door only after the closure of the door through the action of a switch. The door must be closed before the key is removable at the second side of the lock.

A further problem with known security systems is the phenomenon of ‘tailgating’, that is the passage of additional persons through a door along with an authorised person. This problem can mean that a security system may indicate that a building is empty when it is not, since, for example, the system will be unaware of such additional persons remaining after the authorised person has left. Furthermore the additional persons may be unauthorised to pass through the door, rather than simply being colleagues of the authorised person who, for example, uses their key to gain entrance.

### SUMMARY OF THE INVENTION

The current invention provides a locking apparatus for a door comprising a a lock, a key and a sensor which detects whether the door is in a closed position, wherein the key is engageable with the lock at a first side of the door so as to enable the door to be unlocked and the key is subsequently removable from its engagement with the lock only at a second side of the door remote from the first side, wherein the key is only removable, once engaged in the lock, when the sensor senses that the door is in a closed position, and wherein removal of the key causes locking of the door.

The sides of a door relevant in describing the invention are the normal front and rear sides of a door as approached by a person walking up to a door rather than any sides which are effectively edges to be retained in a door jamb. The relevant first and second sides of a door are those sides, which are not simultaneously accessible by one person in normal use when a door is closed.

The locking apparatus of the invention is considered suitable for a wide range of doors, closures, covers, lids, windows, gates and other door-like means for entering from one enclosed space to another space. However, for the purposes of practising the invention the locking apparatus is required to be used with a door where access of one side of the door from another side of the door, when the door is closed, is not reasonably practicable. Therefore, use of the locking apparatus of the invention with doors which are in effect barred doors, gratings and low gates all of which enable access to one side of a closed door from another side of a closed door without opening the door, for example, by a person inserting their hand between bars in such a door or placing their arm over such a door, are not primarily intended for use with the invention. This is because the benefits of the invention, at least in part, relate to the way the locking apparatus, when installed in a door, effectively controls the behaviour of a user of the door/locking apparatus such that a user cannot use a key, in a locking apparatus according to the invention and retrieve that key without at least opening the door. Hence, a user for example, cannot retrieve a key unless the other side of the door is accessed wherein other security features may, for example, be activated.

The locking apparatus according to the invention may include a key in the form of a card. The use of a card is advantageous since a card key has a relatively small cross-section and an aperture can be readily placed in a door such that the card may pass through from one side to another side of the door without the aperture significantly impinging upon or weakening the structure of said door. In addition card keys are more readily carried by a user such as when in credit card format and additional features may be readily combined with use of the lock, such as recording of information about the use of the lock on the card, recording information from the card by a security system to identify a user of the door and so forth.

The locking apparatus according to the invention operates such that the key is only removable, once engaged in the lock, when the door is again locked. Therefore, when a person uses a door equipped with a locking apparatus according to the invention the key is inserted in a first side of the door, the door has to be opened and the door again closed and locked before it is possible to remove the key. Since removal of the key is only possible from the second side of the door it is therefore necessary for the user of a key to have opened the door and passed through the open doorway so as to regain and hence retain the key. This is a significant advantage of the invention, as it requires a given behaviour of a user so as to effectively use a door equipped with the locking apparatus of the invention. In particular, if a user uses their key to open the door for another person the user may therefore be unable to retrieve their key unless they themselves also pass through the door. Furthermore, if the door is made in the form of a turnstile it is possible to ensure, since only one person can pass through the turnstile (door) at one time, that if a key holder uses the key for the benefit of another person the key holder effectively loses their key since it is only accessible by the other person who cannot pass the key back through the door, given the nature of doors suitable for realising the benefit of the invention.

The locking apparatus thus far described relates to the access of a first side of a door from a second side. However, it is with the scope of the invention to provide a locking mechanism according to the aforementioned requirements where users can pass both ways through a door either at will, given the above criteria are met, or alternately from one side of the door to the other and only then back again.

A locking apparatus according to the invention may allow a key to be used from the second side to the first side of the door as it is useable from the first to the second side of the door.

In many situations, particularly where there are several people each with a key requiring common access to an area it is convenient that such key holders may freely pass from one side of the door to the other and back again as they wish. However, the benefits of the invention require that a user must at least open the door after inserting the key so as to retrieve their key and must open the door go through the door and close the door and lock it before they are able to retrieve their key once more. This restricts the ability of a key holder to allow access of third parties without themselves accompanying those people. This is particularly advantageous when a locking apparatus of the invention is used with the door in a situation where accompanied entry to an area is required, for example, by visitors to a prison or such like.

The locking apparatus of the invention may be so arranged that on each subsequent use of the key the functions of the first and second sides of the lock interchange.

Such a function is particularly advantageous in that only one use of the key to pass through the door is possible, such as to access a security area beyond the door, until the person who has gained access to the other side of the door returns back through the door and so once again further access through the door from the first to the second side is enabled. This is particularly beneficial in several situations such as where in a security areas it is important that a second access does not occur while a person occupying a security area is locked in that area such as when a further access may result in a snatch and run theft, for example. Other examples include where a hotel room is only rented to one person in which case use of the room by several people independently is not practicable unless people enter and leave at the same time. Other uses of benefit are for toilet cubicles where a universal key may be supplied, for example on payment of a sum, but once a cubicle is occupied another person also possessing a universal key for such cubical lock is unable to accidentally access an occupied cubicle until that cubicle is rendered vacant once more.

In locking apparatus according to the invention the lock may be conveniently located in a door itself such that use of the key passes the key through from a first side to a second side of the door. Also within the scope of the invention is a situation where the lock is located in a door jamb where the terms the first side and second side of the door for engagement of the key are more broadly construed such that a key, such as a card key placed at a first side of a door jamb, equivalent to a first side of a door and retrieved from the second side of a door jamb, equivalent to a second side of the door (and having similar accessibility criteria) are considered equivalent operations. Similarly other permutations of the location of the lock within the scope of the invention include where the lock is located on both the door and the doorjamb. The term doorjamb includes sides, lintel and foot-board of a door surround.

Depending upon the location of the lock the key may therefore, on passing from a first to a second side of the door, pass through the lock, next to the lock or between lock parts.

It may be advantageous to place a lock in a door jamb since any associated wiring or electronics to further security systems therefore does not require any flying lead between a moveable door and the doorjamb so as to communicate information, for example, from a locking apparatus to other equipment, such as a computer.

A locking apparatus of the invention may include a key, which engages with the lock by means of one or more indentations in the key. One, two or three indentations may be present, or a series of indentations.

Keys are commonly constructed with indentations for engagement with a lock. In the context of the current invention the use of indentations is particularly advantageous as indentations may provide a convenient means for stopping the retrieval of a key once inserted in the lock by means of a catch in the lock to prevent retrieval of the key back on the side the first side, when the key has engaged the lock.

The one or more indentations in the key, which engage the lock, may do so by means of a toothed wheel in the lock apparatus.

Mechanically engaging a key with a toothed wheel is a convenient way in which a linear action of inserting a key into a lock, typically perpendicular to a face of a door enables that mechanical movement to be transferred through 90° so as to enable a bolt or the like to be withdrawn in a lock so as to unlock a door. The toothed wheel may therefore serve to operate the lock to lock and/or unlock the door.

The locking apparatus of the invention may utilise the one or more indentations in the key to retain the key in the lock so as to prevent extraction of the key during part of the operation of the locking apparatus.

Additionally or alternatively, the locking apparatus of the invention may include a key having at least one aperture therein, said at least one aperture serving to enable retention of the key in the lock so as to prevent removal of the key from the lock during operation of the locking apparatus.

To enable effective operation of a locking apparatus of the invention it is necessary to prevent removal of the key from a first side of the door before it is removed from the second side of the door remote from the first side. In many instances it may be appropriate that a key is able to activate a lock by only partial insertion of the key, as an overall physical entity, into the lock such that part of the key protrudes. It is therefore convenient to provide a mechanism whereby the key can be retained in the lock and not removed by force. This is particularly significant when the key is in the form of a card wherein the provision of an indentation in the key may enables the key to be retained in the door such that if excessive force is used to try and remove the key from the door on a first side of the door the key may break off in the lock before removal is possible. Such an action would serve to leave evidence in the lock. The one or more indentations in the key may preferably be present on an edge of the key. The key may be a card key where the presence of an indentation in the edge of a planar card produces a weakness in that card such that exerting force to try and remove a card which has been retained in a lock will potentially cause the card to rip from one edge to the other.

An alternative means for retaining the card in the door is to construct the locking apparatus in a manner whereby it is necessary to engage the key with the lock to such an extent that the key is no longer accessible from the first side of the door when the key is inserted sufficiently that the lock can be unlocked. The key may then protrude on the second side to allow subsequent removal or may only exit onto the second side when the door is opened, by for example, rotating a handle.

The above alternative means for retaining the card in the door may be combined with mechanical retention of the key in the door. Mechanical retention of the key in the door may include clamping means (e.g. lateral clamping) for the key as well as any use of any aperture(s) or indentation(s) in the key as previously mentioned.

Types of keys suitable for use with a locking apparatus of the invention are various types, however, it is preferable that a card key is used and more preferably that a card key in the form of a key suitable for the storage of information is used. When a card suitable for the storage of information is used there may be transfer of stored information between the card and the lock when the key is engaged in the lock. The preferred means of storing the information in the key or the lock is in a digital form. Suitable forms of the digital retention of information include the use of a magnetic strip or an electrical or the aforementioned indentations on the key.

Keys for use with a locking apparatus of the invention may be user specific. Each user may have a separate key, all operable in the same locking apparatus. A part of the locking apparatus or a device, such as a computer to which it may be externally attached, may record the use of user specific keys.

When not in use keys for use with locking apparatus of the invention may be recorded as non-useable by the locking apparatus, such as when a locking apparatus is linked to a computer. Keys when not in use may be retained in a device accessible by a user code. Such variations are particularly suitable in high security areas where there is staff changeover.

A lock for use as part of a locking apparatus of the invention may comprise a mortise lock. A lock for use as part of a locking apparatus of the invention may act as a deadlock mechanism. Furthermore a lock for use with a locking apparatus of the invention may comprise a latch. This is particularly advantageous where, even with use of the invention, a user may still forget to remove a key from the lock after closing the door and the latch. Therefore if a user forgets to remove the key from the door the door can be at least held shut by means of the latch. Disengagement of the latch may not be possible until a key is used. Furthermore, by providing latch if a user of a key opens the door, fails to go through the door and the door once again closes, the user can no longer retrieve the key. This serves to further reinforce the use of a locking apparatus of the invention as a means for requiring given behaviour of a user such as may required to effectively operate a security system. An audible warning may be provided by the locking apparatus whilst the door is open and/or unlocked to remind a user to not leave a door open or to retrieve their key.

The lock of a locking apparatus of the invention may operate to secure a door by means of a solenoid operated bolt.

The lock of a locking apparatus of the invention may operate to stop a door handle operable to release a door from being operated such as by rotation.

The locking apparatus according to the invention may be advantageously combined with a number of other features. Other features include the use of audible, visual or tactile signals operable when the door is in an open position or when a door in an open position longer than a given time so as to alert the user to the need to close the door, lock the door and retrieve the key.

A further aspect of the invention comprises a security system. The sensor that detects if the door is in a closed position may be linked to a central computer control such as are commonly used in hotels, prisons and other institutions whereby a central controller may monitor and/or adjust the access to doors and other features of the system from a central point. Other features of such a system may include the potential for in situ reprogramming of key cards and the like. A security system according to the invention may comprise the audible, visual and tactile signalling means for operation when the door is in an open position and/or when the key is in the lock even if the door is in a closed position so as to help ensure the a user remembers to close the door and/or when closed to lock the door and /or when locked the user retrieves the key from the door.

According to a further aspect of the invention a modified security system comprises a locking apparatus as previously described, a door on which the lock is mounted, a detector means for detecting the presence of a user and a computer control unit capable of receiving data from the detector means and of controlling the lock, wherein the key is only removable from the lock when data passed from the key to the computer control unit correlates with data passed from the detector means to the computer control unit.

The detector means may be a light curtain or a weight sensitive pad or a pressure sensitive pad or any combination of these. The door may be in association with a further door connected to the first by a passage such that passage through the further door is only possible after a user has retrieved the key from the first door.

As used herein a light curtain comprises a source of light over an area and detectors for that light such that the presence of a person or object in the area is detectable by the detectors for communication in electronic form. A weight sensitive pad is a device for measuring and communicating in electronic form the weight of an object on the pad. A pressure sensitive pad is a device for detecting the area of a surface on which an object, such as a foot, is present, and communicating that information in electronic form.

A locking apparatus of the invention, while used with a door, may be sold as a kit of parts comprising a lock and one or more key cards for the lock, which operate as previously described. It is considered within the scope of the invention that security systems and locking apparatus according to the invention may incorporate over ride and master key type operations such that, for example, on failure of the locking apparatus or in an emergency access through the door is still possible. Furthermore, locking apparatus of the invention may be constructed such that it is necessary to utilise two or more keys simultaneously or in sequence so as to activate, ie lock or unlock the locking apparatus. Such simultaneous use may be from the same or from opposing sides of the door.

Other features of a locking apparatus or security system of the invention may require a mode of operation of the locking apparatus such that it is necessary to pass a key from a first side of the door to the second side of the door, wherein the second side of the door is still not accessible and that a second person use the key on the second side of the door through to the first side of the door, ie a pass-back arrangement, before the door can be unlocked. This has the advantage that not only does the key act to lock or unlock the door but the key, for example, in the form of an identity pass is safely passed to security personnel on the second side of the door for checking before it is possible for the door to be opened. The door is thereby only opened when the security personnel pass the card back from the second side of the door to the first side of the door, returning it to the key holder and also allowing the key holder access. This aspect of the invention conveniently allows security personnel on a second side of the door to retain the key and deny access to a person on the first side of the door without ever having to come into contact with the person on the first side of the door, as for example, may be appropriate in high security situations.

The locking apparatus of the invention is considered to minimally comprise the lock and the key, however, it may also be considered to comprise the door and any bolt-retaining means.

### BRIEF DESCRIPTION OF THE DRAWINGS

The invention will now be illustrated by means of the following drawings in which:

FIG. 1 is a partial elevation of a side of a door equipped with a lock forming part of locking apparatus according to the invention;

FIG. 2 shows a card key of a locking apparatus of the invention;

FIG. 3 is a partial side elevation of an edge of a door equipped with a lock forming part of a locking apparatus according to the invention;

FIG. 4 is a schematic representation of a first security system according to the invention;

FIG. 5 is a schematic representation of a second security system according to the invention;

FIG. 6 is a schematic representation of a third security system according to the invention;

FIG. 7 is a schematic representation of a fourth security system according to the invention;

FIG. 8 it is a circuit diagram of an alternative locking apparatus in accordance with the invention; and

FIG. 9 is an alternative version of card key for use with locking apparatus of the invention as represented by the diagram of FIG. 8.

### DETAILED DESCRIPTION OF THE INVENTION

In the Figures, like numbers represent like features.

Referring now to FIG. 1, a practical embodiment of locking apparatus of the invention includes a lock 4 which is located in a door 10 which is mounted in a door jamb 12 by means of hinges (not shown).

A card slot 16 is arranged perpendicular to a first face 24 of the lock 4 which itself is co-planar with a first face 14 of the door 10. The lock also comprises a handle 30 which may be manually rotated to engage and withdraw a door bolt 40 which engages with a bolt retaining means 44 in the door jamb 12. The ability to rotate the handle 30 is determined by the activation or otherwise of a locking solenoid 58. Alternatively, such a solenoid may be used to engage with the bolt 40 or in alternative embodiments no solenoid may be required and a purely mechanical interaction may be present between the handle 30, the bolt 40 and the other portions of the lock, so as to enable locking and unlocking of the door 10.

The lock 4 comprises the card slot 16 in which a card key 6 is engagable. The card slot 16 is associated with a card key reading means in the form of a magnetic strip reading means 50 and optional card clamping means 52 to engage with the card key 6 when inserted into the card slot 16. Inserting the card key 6 into the lock 4 serves to unlock the lock. Removing the card key 6 from the lock 4 enables the user to retain the key and is contingent upon the door being locked. When the door is closed when used with an electrically operated locking apparatus of the invention removal of the card may cause the door to be locked.

FIG. 2 shows the card key 6 for use with the locking apparatus of FIG. 1. The card key 6 comprises a plastic credit card-type key with a lower edge comprising a plurality of indentations 26 for engagement in the lock. The card key 6 also comprises a magnetic strip 56 for reading by the lock 4, using magnetic strip reading means 50.

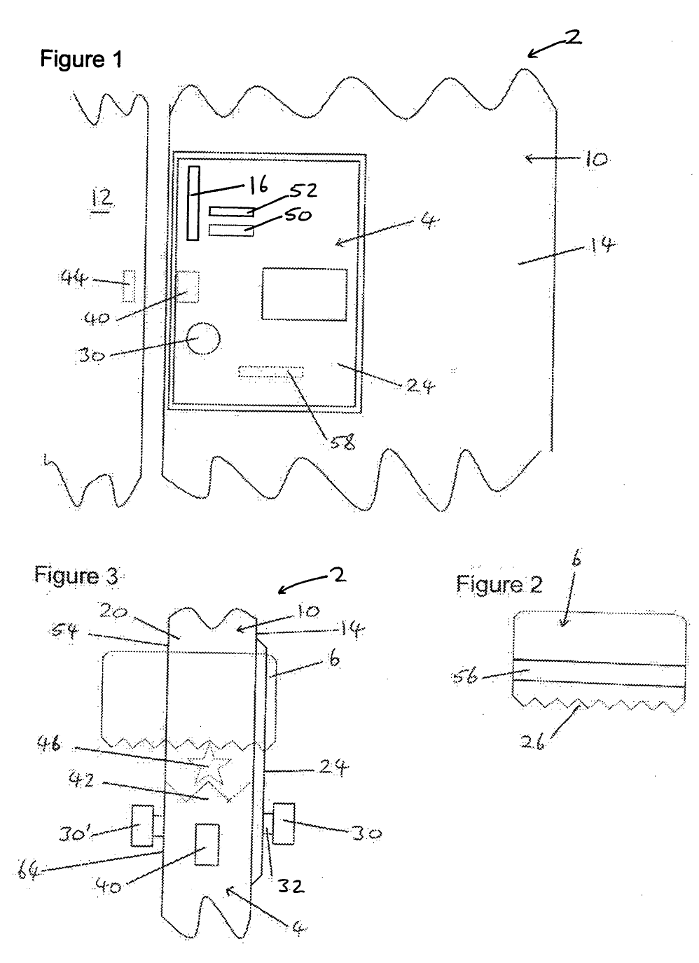

As shown in FIG. 3, the lock 4 is located in the door 10 such that the lock 4 is accessible from a first face 24 of the lock located on a first face 14 of the door and from a second face 54 of the door 10 where a second face 64 of the lock 4 is present. The card 6 may therefore be engaged in the first face 24 of the lock 4 by means of the card slot 16 and the card 6 may exit the second face 64 of the lock 4 on the second side of the door 54.

A star wheel 46 in the form of a toothed wheel is present in the mechanism of the lock 4. The indentations 26 on the bottom face of the card key engage with the star wheel 46 as the card key 6 is placed into and traverses through the card slot 16 which is located between the first face 24 and the second face 64 of the lock 4. The star wheel 46 is engagable by a retaining mechanism 42 which enables rotation of the star wheel 46 to be prevented such that the card key 6 may no longer be traversed through the card slot 16 in the lock 4. If the lock 4 recognises that the key 6 is valid then a user may rotate the handle 30 which is located on a spindle 32 such that the bolt 40 may be retracted into the lock, or extended from the lock 4 with respect to the side face 20 of the door 10.

In use, when the card key 6 is inserted into the card slot 16 the card key 6 rotates the star wheel 46 until the card key is fully engaged with the lock, at which point the star wheel 46 is prevented from rotation by the retaining mechanism 42. The bolt 40 may then be withdrawn by rotating the handle 30 if the key has been recognised by the lock. The door is opened and the key holder goes through the door 10, closes the door 10 and locks the door using the handle 30′ to extend the bolt 40. The retaining means 42 then releases the star wheel 46 and the key card 6 may be removed from the second side 54 of the door 10. During the operation of the lock 4, the card key 6 is not removable from the (first) side 14 of insertion after the indentations 26 are engaged by the star wheel 46. Once engaged, the star wheel 46 is retained by a ratchet mechanism such that the card key 6 can only be inserted further into the card slot 16 and not retrieved from the first side 24 of the lock 4.

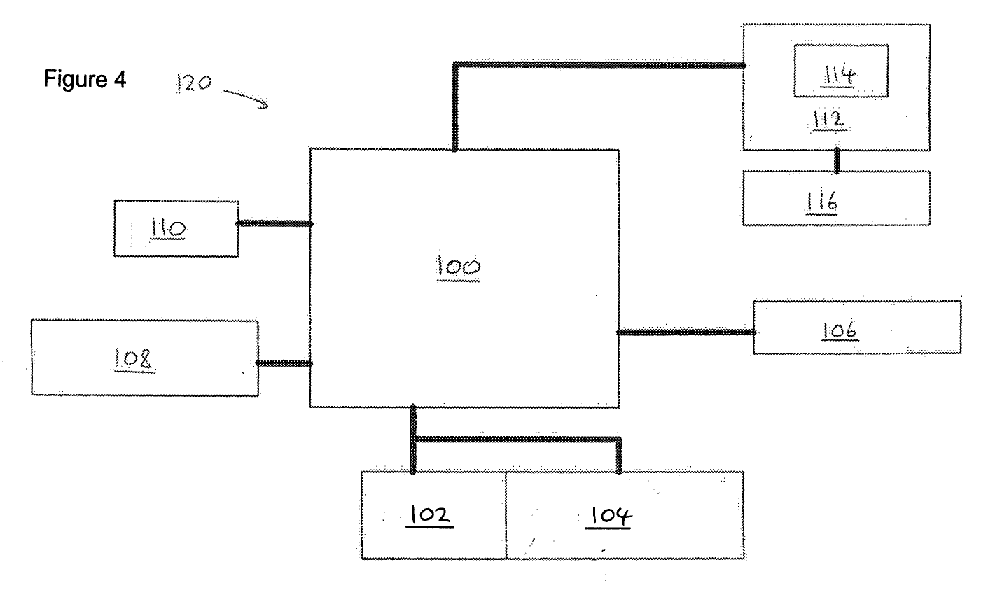

FIG. 4 shows a schematic view of a first security system according to the invention which comprises a locking apparatus 4 as previously described. The security system comprises a door lock control logic 100 which is interfaced with a number of other elements including a card reader 102 for reading a card key 6 and a card locking solenoid 104 for engaging a means to retain the card key 6 in the door 10 when signalled to do so by the door control logic 100. The door control logic 100 is also interfaced with a door lock solenoid 106 for locking and/or unlocking the door 10, a door position sensor 108 for sensing whether the door 10 is in an open or closed position and a door alarm 110 for giving a visual, auditory or other sensory signal to a user during operation of the security system. The door lock control 100 is also interfaced to a master computer 112 which has a control interface 114 whereby an operator may remotely operate the door control logic 100 and other similar locking apparatus as herein before described. Also interfaced to the master computer 112 is a card programmer 116 whereby the key card 6 may be programmed or reprogrammed so as to be recognised or otherwise by the door control logic 100.

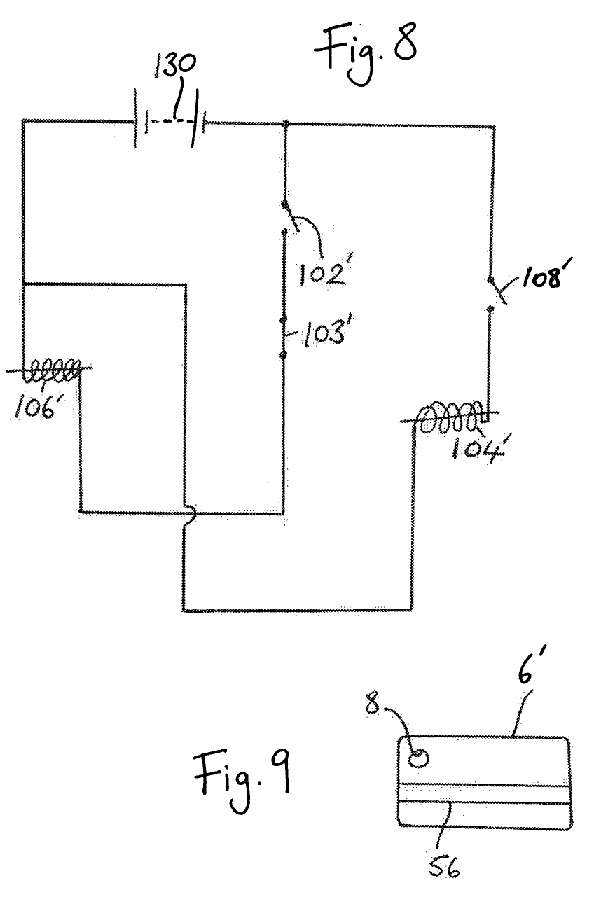

FIG. 8 is a circuit diagram for a modified embodiment of locking apparatus in accordance with the invention. The mechanical parts of the apparatus are similar to those illustrated in FIGS. 1, 2 and 3, but it does not include a star wheel or equivalent for inter engagement with the indentations of the card key to enable a purely mechanical mechanism for moving the card key through from a first to a second side of the lock/door, with a one-way mechanism and retention means to prevent withdrawal of the card. Instead, in this modified embodiment, electrical circuits with solenoids are employed for clamping and releasing the card key and for locking and unlocking the door itself. Also, the card key 6′ in this modified embodiment, as shown in FIG. 9, does not have indentations along its edge. Instead, it has at least one aperture 8 by means of which it can be clamped into the lock, as will be explained.

The circuit includes a power source 130, which may be a 12 V DC battery. Additional components of the circuit, comparable to the system of FIG. 4, include a switch 108′ which is operable by a sensor (not shown) which detects when the door is open or closed, switches 102′, 103′ which are part of a card reader arrangement, a first solenoid 104′, which operates to clamp the card 6′ in the lock, and a second solenoid 106′, which operates a door lock bolt, comparable to bolt 40 of FIGS. 1 and 3.

In operation, when the card 6′ is inserted into the lock, at the first side of the door, if the card reader recognises the card as authorised for access, the switches 102′, 103′ are closed. This energises the solenoid 106′, which causes withdrawal of the door lock bolt, i.e. unlocking of the door. The door can then be opened by the user. When the aforesaid sensor detects that the door is opened, it causes the switch 108′ to close. This actuates the solenoid 104′, causing a bolt or similar to clamp the card 6′ by engaging through the aperture 8 in the card 6′. Therefore, the card 6′ cannot be removed from the door, and from the lock, while the door is open. Once the door is closed again, the sensor deactivates the solenoid 104′, so the card 6′ is unclamped. The card 6′ can then be withdrawn from the second side of the door. This causes opening of one of the switches 102′, 103′, thereby deactivating the solenoid 106′ and relocking the door by means of the door lock bolt.

In summary, when an authorised card 6′ is inserted in the lock, the door is unlocked. When the door is subsequently opened, the card 6′ is clamped in the lock and cannot be removed. Once the door is closed again, the card 6′ is unclamped. Upon removal of the card 6′, which is only possible from the second side of the lock/door, the door is automatically locked again.

When the card 6′ is initially inserted in the lock, it needs to be inserted until it is flush with the face of the door. Therefore, it cannot be removed again from that side, as it cannot be grasped by the user. In this position, and it may already project at the second side of the door. Therefore, once the door has been unlocked and the user has passed through, he/she can grasp the card 6′ at the second side and pull it out. Alternatively, the card 6′ may be retained completely within the door and a further mechanism may be required to move it on to protrude from the second side.

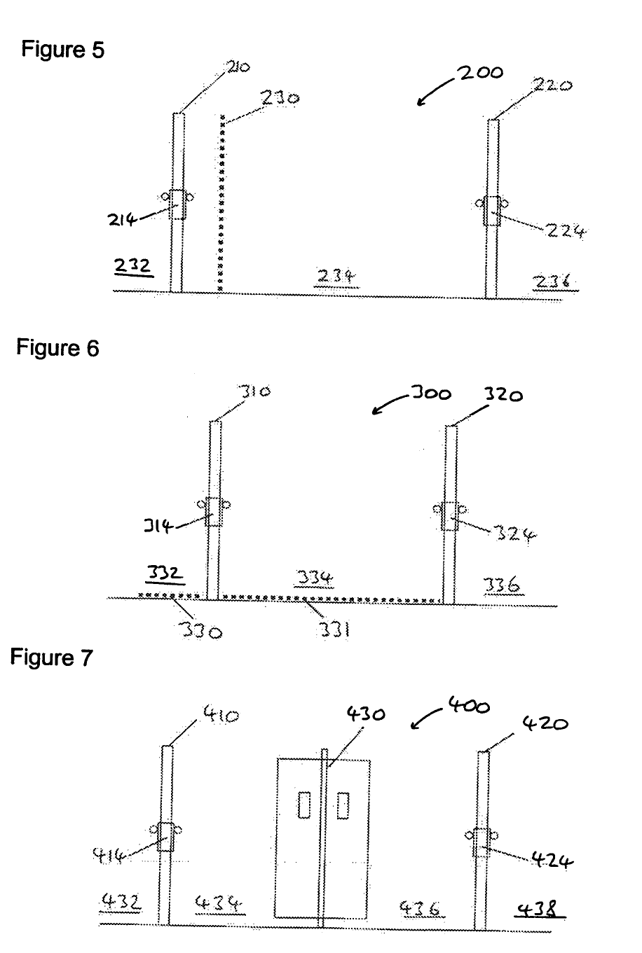

FIG. 5 shows a schematic view of a second security system 200 according to the invention. The system 200 comprises a corridor with an entrance door 210 and an exit door 220. Both doors 210, 220 are equipped with a pass through card lock 214, 224 of the type 4 shown in FIGS. 1 and 2. The corridor is equipped with a light curtain 230 in a passageway 234 between the doors 210, 220.

In use a user standing on the threshold 232 of the entrance door, places their card key 6 into the lock 214, opens the door 210, passes through the doorway, under light curtain 230 and into the passageway 234. The user then closes, and preferably locks the entrance door 210 and attempts to remove their card key 6. If the light curtain 230 has been interrupted in such a manner as to indicate the passage of only one person the card key 6 may be retrieved from the door. Additionally the exit door 220 is either automatically unlocked or rendered susceptible to unlocking by use of the card key 6 in the further locking apparatus 224 such that the user may pass on into secure area 236. This system of the invention therefore provides a means by which only individual users may pass through from one area 232 to another area 236 by means of an individual card key 6. The problem of ‘tailgating’ is therefore overcome.

FIG. 6 shows a schematic view of a third security system 300 according to the invention. The system 300 comprises a corridor with an entrance door 310 and an exit door 320. Both doors 310, 320 are equipped with a pass through card lock 314, 324 of the type 4 shown in FIGS. 1 and 2. The corridor is equipped with a first weight sensitive pad 330 at the threshold 332 of the entrance door 310 and a second weight sensitive pad 331 covering all floor parts in a passageway 334 between the entrance 310 and exit 320 doors.

In use a user standing on the threshold 232 of the entrance door is weighed by the first weight sensitive pad 330 and places their card key 6 into the lock 214. If weight information communicated from card key 6 to the system 300 correlates in a pre defined manner with the weight information from the weight sensitive pad 330 the lock 314 is unlocked. The user then, opens the door 210, passes through the doorway, into the passageway 234 locks the entrance door 210 and attempts to remove their card key 6. If their weight, as measured by the second weight sensitive pad 331, correlates with the aforementioned weight information the card key 6 may be retrieved from the door. Additionally the exit door 320 is either automatically unlocked or rendered susceptible to unlocking by use of the card key 6 in the further locking apparatus 324 such that the user may pass on into secure area 336. The term correlates indicates that a computational process is undertaken in which the two pieces of information are compared and if found to be equal as defined by predetermined parameters, such as maximum weight variation, they are then said to correlate. This system of the invention therefore provides a further means by which only individual users may pass through from one area 332 to another area 336 by means of an individual card key 6. The problem of ‘tailgating’ is therefore overcome.

In a variation on the third security system of the invention 300 the weight sensitive pads may be replaced by pressure sensitive pads by which means ‘footfall’ may be measured, i.e. number of footprints on the pad. Only if footfall correlates with that concomitant with the presence of a single person are the required correlations obtained and the locks 314, 324 rendered openable or the card 6 releasable.

In a further variation of the third system and the aforementioned first variation thereon the threshold pad (e.g. 330) may be omitted together with its associated control function.

FIG. 7 shows a schematic view of a fourth security system 400 according to the invention. The system 400 comprises a corridor with an entrance door 410 and an exit door 420. Both doors 410, 420 are equipped with a pass through card lock 414, 424 of the type 4 shown in FIGS. 1 and 2. The corridor is equipped with a revolving door 430 of four chambers (not shown) each suitable for accommodating only one person with passageways 434, 436 on either side and between the doors 410, 420.

In use a user standing on the threshold 432 of the entrance door, places their card key 6 into the lock 414, opens the door 410, passes through the doorway, into a passageway 434. The user then closes, and locks the entrance door 410 and removes their card key 6. The revolving door 430 is now activated to allow one quarter turn only, such that the person may move through the door 430 between the passageways 434, 436. Optionally additionally the exit door 420 is present to allow a user to exit in the same manner from the area 438 protected by the security system. This system of the invention therefore provides a means by which only individual users may pass through from one area 232 to another area 236 by means of an individual card key 6.

Each of the second to fourth security systems may utilise subsidiary equipment, such as parts described for the first security system for its operation. By means of these security systems the problem of ‘tailgating’ may be overcome.

1. A locking apparatus for a door comprising a lock, a key and a sensor which detects whether the door is in a closed position, wherein the key is engageable with the lock at a first side of the door so as to enable the door to be unlocked and the key is subsequently removable from its engagement with the lock only at a second side of the door remote from the first side, wherein the key is only removable, once engaged in the lock, when the sensor senses that the door is in a closed position, and wherein removal of the key causes locking of the door.

2. A locking apparatus as set forth in claim 1 wherein the key is in the form of a card.

3. A locking apparatus as set forth in claim 1 wherein the key is capable of being used from the second side to the first side of the door as it is useable from the first to the second side.

4. A locking apparatus as set forth in claim 1 wherein on each subsequent use of the key the function of the first and second sides of the lock interchange.

5. A locking apparatus for a door as set forth in claim 1 wherein the key has at least one indentation formed therein and engages the lock apparatus by means of said at least one indentation.

6. A locking apparatus as set forth in claim 1 wherein the key has one or more indentations therein and the lock apparatus includes a toothed wheel, and wherein the key engages with the lock apparatus by engagement of said indentations with said toothed wheel.

7. A locking apparatus as set forth in claim 6 wherein the toothed wheel serves to operate the lock so as to unlock a locked door or lock an unlocked door.

8. A locking apparatus as set forth in claim 1 wherein the key has at least one aperture therein, said at least one apertures serving to enable retention of the key in the lock so as to prevent removal of the key from the lock during operation of the locking apparatus.

9. A locking apparatus as set forth in claim 1 wherein it is necessary, so as to unlock the door, to insert the key into the lock to such an extent that the key is no longer accessible from the first side of the door.

10. A security system comprising:
a locking apparatus for a door, said locking apparatus comprising a lock, a key and a sensor which detects whether the door is in a closed position, wherein the key is engageable with the lock at a first side of the door so as to enable the door to be unlocked and the key is subsequently removable from its engagement with the lock only at a second side of the door remote from the first side, wherein the key is only removable, once engaged in the lock, when the sensor senses that the door is in a closed position, and wherein removal of the key causes locking of the door;
a door on which said lock apparatus is mounted;
a detector means for detecting the presence of a user; and
a computer control unit capable of receiving data from the detector means and from the key and of controlling the lock apparatus, wherein the key is only removable from the lock when data passed from the key to the computer control unit correlates with data passed from the detector means to the computer control unit.

11. A security system as set forth in claim 10 wherein the detector means comprises a light curtain and/or a pressure sensitive pad.

12. A security system as set forth they in claim 10 further comprising a further door and a further lock associated therewith, said further lock also being controlled by the computer control unit so as to allow passage through said further door only after the key has been retrieved from the lock in the first mentioned door.
